(19) United States
(12) Patent Application Publication
(10) Pub. No.: US 2012/0150784 A1
(43) Pub. Date: Jun. 14, 2012

(54) Immersive Planning of Events Including Vacations

(75) Inventors: Vijay Mital, Kirkland, WA (US); Oscar E. Murillo, Redmond, WA (US); Darryl E. Rubin, Duvall, WA (US); Colleen G. Estrada, Medina, WA (US)

(73) Assignee: MICROSOFT CORPORATION, Redmond, WA (US)

(21) Appl. No.: 12/965,860

(22) Filed: Dec. 11, 2010

(51) Int. Cl. G06N 5/02

(52) U.S. Cl. 706/46

(57) ABSTRACT

The subject disclosure is directed towards a web service or the like that assists users in generating a plan, such as a vacation plan. In one aspect, a user chooses a model that generates a plan, including by selecting content objects (e.g., found by searching) corresponding to plan objects. Selection is based upon user input, along with rules, constraints and/or equations associated with the model. A presentation mechanism produces a presentation (e.g., an audiovisual experience) from the content/plan objects, such as a linear narrative, a timeline, a schedule, a calendar, a gallery, a list, and/or a map. The plan may be annotated with annotation data. The plan may be interacted with to re-plan it, and may be saved and/or provided to another user for viewing and/or re-planning. Plan versions may be compared to see the changes made.

### CROSS-REFERENCE TO RELATED APPLICATIONS

The present application is related to copending U.S. patent applications entitled “Addition of Plan-Generation Models and Expertise by Crowd Contributors” (attorney docket no. 330929.01), “Synthesis of a Linear Narrative from Search Content” (attorney docket no. 330930.01), and “Using Cinematographic Techniques for Conveying and Interacting with Plan Sagas” (attorney docket no. 331022.01), each assigned to the assignee of the present application, filed concurrently herewith and hereby incorporated by reference.

### BACKGROUND

Planning an event like a vacation, wedding or conference is a difficult and laborious task, as there are enormous amounts of variables, options, goals and other factors that can be considered when making the plan. For example, a vacation plan may need to consider a number of locations, how many days to spend at each location, what to do at each location, where to stay, how to travel, how much to spend, and so forth.

A person planning something along these lines may search the Internet to help get ideas and to start narrowing down the possible choices. However, the amount of content returned for a search can be overwhelming, and many times much of it is irrelevant or impractical to use. Further, while a human can recognize a relationship between the diverse concepts related to an event, a search engine generally cannot. As a result, multiple searches typically need to be performed to find desired content, with choices being made on multiple sites and mentally pieced together by the user.

Some technology exists to help users with this task, but one of the biggest problems with existing technology is that the experience of putting the plan together, including doing all the what-ifs needed to get to something the user likes, is both boring (e.g., via criteria sliders and pickers, significant sorting/filtering operations, and so forth) and mentally taxing in the sense that a plan made in this way is difficult to understand, and is difficult to keep track of the choices. Another big problem is that a plan or partial plan is difficult for the non-planner to understand, so it is usually even more difficult and confusing to involve a spouse/friend/travel agent in the planning exercise. For example, the planner may not recall why most of the choices were made from those available, and/or to recall the possibly many alternatives that were considered and found acceptable but not actually chosen.

What is needed an experience in which a planner can experience what a proposed planned event may look or feel like, along with an understanding of the impact of the various choices made, and the ability to make further choices to refine the plan. What is further needed is an experience that can be communicated to and easily understood by someone other than the first planner, as well as an experience that can be revised, augmented or added to by a second person, for communication back to the first planner who can understand what changed.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology (e.g., provided by a web service) by which a model is used to generate a plan, including by selecting and substituting content objects (e.g., found by searching) for plan objects of a plan. Selection is based upon user input, along with rules, constraints and/or equations associated with the model.

A presentation mechanism produces a presentation (e.g., an audiovisual experience) based upon the plan objects for consumption by the user. The presentation may be in the form of a linear narrative, a timeline, a schedule, a calendar, a gallery, a list, and/or a map and so on. The plan may be annotated with associated annotation data, such as audio or text notes, comments, flags and the like.

In one aspect, the plan may be interacted with to allow one or more changes to the plan objects (e.g., change a plan object or select and substitute a different content object for the plan object). When such a change is made, the presentation mechanism reprocesses the changed plan objects into a modified presentation. The user may also interact to change the information input to the model, whereby the model detects the interaction and in response regenerates a new/revised plan, which results in a new/revised presentation.

In one aspect, the plan may be saved and shared with another user. The other user may similarly interact to re-plan that plan, annotate it, and/or save/communicate it back to the original planner or another user. That revised plan may be further re-planned and so on. Plans may be compared to evaluate the changes that were made.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing example components for authoring a model that generates a plan and viewing a presentation of that plan.

FIG. 2 is a flow diagram representing example steps related to maintaining and accessing models by authors and users.

FIG. 3 is a representation of how a high-level plan may incorporate lower level plans.

FIG. 4 is a representation of interactive presentation shown in various presentation types on a user interface.

FIG. 5 is a block diagram representing exemplary non-limiting networked environments in which various embodiments described herein can be implemented.

FIG. 6 is a block diagram representing an exemplary non-limiting computing system or operating environment in which one or more aspects of various embodiments described herein can be implemented.

### DETAILED DESCRIPTION

Various aspects of the technology described herein are generally directed towards allows users (planners) to generate a proposed event plan and then visualize and/or virtually experience the proposed plan by way of audio/video/textual/signal content associated with objects within the plan. The technology also provides planners with the ability to use such a virtual experience as a framework for making further choices, thus refining the planned experience. Once generated, a plan may be saved, and shared with one or more others (e.g., a second person) who can similarly visualize and/or virtually experience the proposed plan. The second person may edit (add/delete/change) the plan objects, mark up the plan and flag or comment upon any of the objects or choices in the plan. One or more plan versions, such as a before and after version of a plan, may be compared to see the impact of any re-planning.

It should be understood that any of the examples herein are non-limiting. For one, while the examples primarily describe plans for vacations, it is understood that anything that may be planned, such as a wedding, a house remodel and so forth may use the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computer assisted planning and modeling in general.

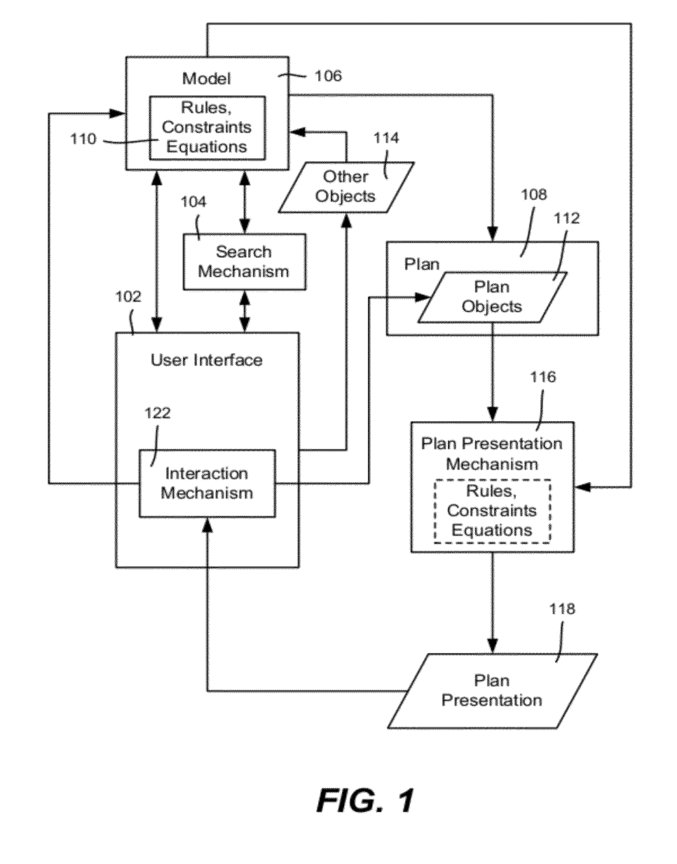

FIG. 1 shows example components, such as implemented in a web service, directed towards plan generation and usage. In general, a user interested in planning an event or set of events interacts through a user interface 102 (which may leverage a search mechanism 104) to select a particular model 106. The model may be selected from among many such plans, including one that was authored as described in the aforementioned U.S. patent application entitled “Addition of Plan-Generation Models and Expertise by Crowd Contributors.”

In general, once a model 106 is selected, via the user interface 102 the user provides input (e.g., parameters) to the model 106 in order to generate a plan 108. As shown in FIG. 1, a single user interface 102 is shown, however it is understood that any component may have its own user interface capabilities, or may share a user interface with another component. Indeed, the components shown in FIG. 1 are only examples; any component exemplified in FIG. 1 may be combined with any other component or components, or further separated into subcomponents.

Each such model such as the model 106 includes rules, constraints and/or equations 110 for generating the relevant plan 108 to fit user input parameters and/or goals, as well as for generating other useful devices such as a schedule. For example, for a “Tuscany vacation” model, a rule may specify to select hotels based upon ratings, and a constraint may correspond to a total budget. An equation may be that the total vacation days equal the number of days in the Tuscany region plus the number of days spent elsewhere; e.g., if the user chooses a fourteen day vacation, and chooses to spend ten days in Tuscany, then four days remain for visiting other locations, (total days=Tuscany days+other days). Additional details about models and plans are described U.S. patent application Ser. No. 12/752,961, entitled “Adaptive Distribution of the Processing of Highly Interactive Applications,” hereby incorporated by reference.

There may be many models from which a user may select, as described in the aforementioned U.S. patent application entitled “Addition of Plan-Generation Models and Expertise by Crowd Contributors.” For example, one user may be contemplating a skiing vacation at a particular ski resort, whereby that user will select an appropriate model, while another user planning a beach wedding will select an entirely different model. Moreover, there may be multiple models for the same concept; for example, there may be several models for a Tuscany vacation, comprising a family model, a couples model, a first-class model, a low-budget model, a three-day model, and so on. Note that a single model may combine some of these concepts, and be controlled with input parameters that determine how the model generates a plan. For example, one model input parameter may be a “budget” input, whereby accommodations selected for the plan are selected base upon the budget amount. In other words, a single model may include both concepts of a first-class model and a low-budget model, with the model operating to select appropriate plan objects based on a user-input budget parameter, for example. In general, it is left up to a model author to determine how narrowly or broadly to focus a model's rules, constraints and/or equations, along with how to use input parameters to generate a desired plan for a user.

The selected model 106 may generate separate searches for a concept. By way of the “beach wedding” example, the selected model 106 may be pre-configured to generate searches for beaches, water, oceanfront views, weddings, and so forth to obtain beach-related and wedding-related search content (objects). The model 106 may also generate searches for bridesmaid dresses, hotels, wedding ceremonies, wedding receptions, beach wedding ceremonies, beach wedding receptions and so forth to obtain additional relevant objects.

To develop the plan 108, the model 106 applies the rules, constraints and/or equations 110 to balance parameters and goals input by the user, such as budgets, locations, travel distances, types of accommodation, types of dining and entertainment facilities used, and so forth. The content that remains after the model 106 applies the rules, constraints and/or equations 110 comprise content objects corresponding to the plan objects 112 that are used in presenting a plan to the user. Note that non-remaining search content need not be discarded, but rather may be cached, because as described below, the user may choose to change their parameters and goals, for example, or change the set of objects, resulting in a changed plan.

The search mechanism 104 includes technology (e.g., a search engine or access to a search engine) for searching the web and/or private resources for the desired content objects, which may include images, videos, audio, blog and tweet entries, reviews and ratings, location postings, and other signal captures related to the plan objects 112 contained within a generated plan 108. For example, objects in a generated plan related to a vacation may include places to go to, means of travel, places to stay, places to see, people to see, and actual dining and entertainment facilities. Any available information may be used in selecting and filtering content, e.g., GPS data associated with a photograph, tags (whether by a person or image recognition program), dates, times, ambient light, ambient noise, and so on. Language translation may be used, e.g., a model for “traditional Japanese wedding” may search for images tagged in the Japanese language so as to not be limited to only English language-tagged images. Language paraphrasing may be used, e.g., “Hawaiian beach wedding” may result in a search for “Hawaiian oceanfront hotels,” and so forth.

Note that a user may interact with the search mechanism 104 to obtain other objects. A user may also provide such other objects 114 to the model 106 for consideration in generating a plan, such as the user's own photographs and videos, a favorite audio track, and so on, which the model may be configured to use when generating the content objects corresponding to the plan objects 112.

The plan is then presented to the user in via a plan presentation mechanism 116, which processes the content objects into suitable audio, visual and/or tactile output for consumption (and interaction therewith) by the user, as specified by the model (or possibly another source, such as a different model). One type of presentation in which the presentation mechanism 116 includes a content synthesizer corresponds to a synthesized linear narrative, as further described in the aforementioned U.S. patent application entitled “Synthesis of a Linear Narrative from Search Content.” Other types of presentations are described below.

As represented in FIG. 1 via the interaction mechanism 120, the user may interact to make choices associated with any objects referred to in the presentation of the retrieved content. For example, a user may choose to delete a photograph that is not wanted. A user may delete a category, e.g., do not show large hotels, because the user wants to stay only at bed-and-breakfast type places. A user also may specify other changes to the model parameters, e.g. whether a proposed villa needs to be replaced with a cheaper alternative. The user may interact with the model 106, plan objects 108 and/or other data (e.g., the other objects 114) to make choices that are global in nature, or choices that cross multiple objects in the display of the retrieved content, e.g. total number of days of a trip, or total budget.

Whenever the user makes such a change or set of changes, the model 106 may regenerate a new plan, and/or the plan presentation mechanism 116 may generate a new presentation. In this way, a user may perform re-planning based on any changes and/or further choices made by the user, and be presented with a new presentation. As described below, the user may compare the before and after plans upon re-planning, such as to see a side by side presentation of each; the plan or various alternative plans may be saved for future reviewing, providing to others for their opinions and feedback, and so forth.

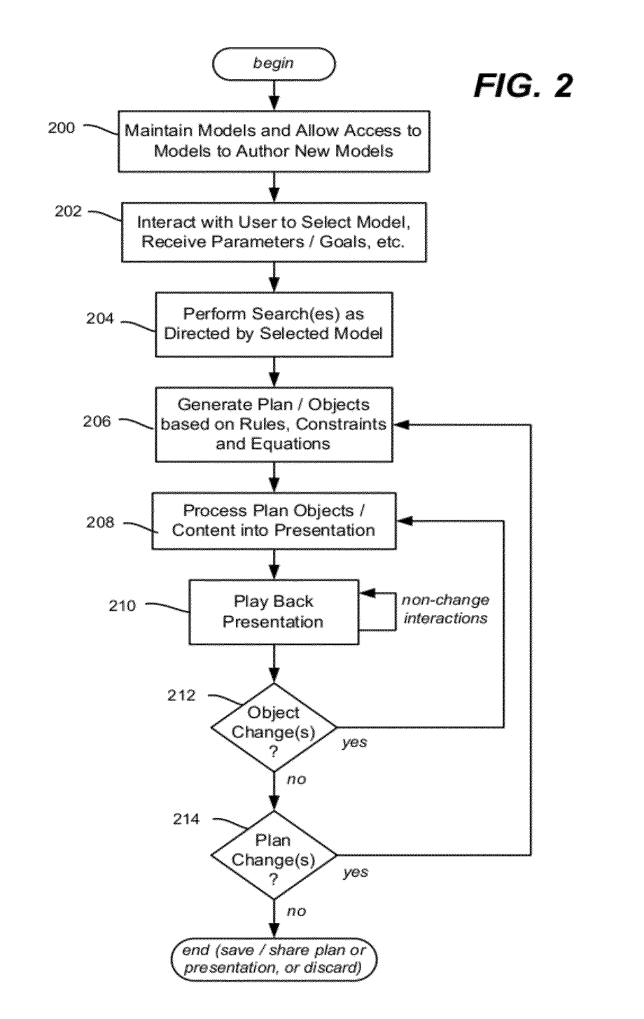

FIG. 2 is an example flow diagram summarizing some of the concepts described above with respect to author and user interaction and component operations. Step 200 represents maintaining the various models or sets of models, and allowing authors (including crowd contributors) to access the models in order to develop new models therefrom. Note that the models may be maintained in virtually any way, possibly to facilitate efficient searching, by categories or relationships, and so forth.

Step 202 represents a service or the like interacting with a user to select a model and provide it with any relevant data. For example, a user may be presented with a wizard, selection boxes or the like that first determines what the user wants to do, e.g., plan an event, take a virtual tour, and so forth, eventually narrowing down by the user's answer or answers to match a model. For example, a user may select plan an event, then select from a set of possible events, e.g., plan a vacation, plan a wedding, plan a business meeting, and so forth. If the user selects plan a vacation, for example, the user may be asked when and where the vacation is to take place, a theme (skiing, golf, sightseeing, and so on), a budget limit and so forth.

By way of example, consider a user that interacts with a service or the like incorporated into Microsoft Corporation's Bing™ technology for the purpose of making a plan. One of the options with respect to the service may be to select a model, and then input parameters and other data into the selected model (e.g., a location and total budget). With this information, the search for the content may be performed (if not already performed in whole or in part, e.g., based upon the selected model), processed according to the rules, constraints and equations, and provided to the presentation mechanism 116. The presentation mechanism 116 generates the plan presentation 118 in a presentation form may that be specified by the model or user selection (play a narrative, show a timeline, and so on).

Thus, via step 202, a model may be selected for the user based on the information provided. Further, the user may be presented with a list of such models if more than one applies, e.g., “Low cost Tuscany vacation,” “Five-star Tuscany vacation” and so forth.

Step 204 represents performing one or more searches as directed by the information associated with the model. For example, the above-described beach wedding model may be augmented with information that Hawaii is the desired location for the beach wedding, sunset the desired time, and search for hotels on Western shores of Hawaii, images of Hawaiian beaches taken near those hotels, videos of sunset weddings that took place in Hawaii, and so on. Alternatively, a broader search or set of searches may be performed and then filtered by the model based upon the more specific information.

Once the content is available, step 206 represents generating the plan according to the rules, constraints and equations. The result is a set of content objects that correspond to (at least some of) the plan objects to be presented to the user.

Note that the planner is not limited to a single plan, and instead, for example, may incorporate other plans into a high level plan 302. These other plans may be found in any way, including by having the service suggest them. For example, if a user chooses model K, models C and V may be suggested as likely being useful. This may be because the service has a noted an affinity between models K, C and V, such as based upon other user's behavior, linguistic (e.g., terminological) affinity, user feedback and reviews, and so forth.

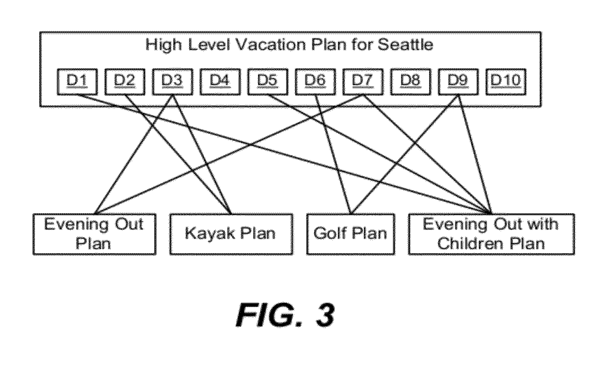

By way of example of multiple plans, FIG. 3 shows how a ten day (D1-D10) Seattle vacation plan may be selected from a corresponding model, in which the high level plan 302 is laid out linearly in a timeline or the like. Some of the days (D4, D8 and D10 in this example) may have activities provided by the high-level plan, such as sightseeing activities, or need not have anything planned. Other days have plans generated from other models incorporated into them, e.g., the day D1 has a plan for spending the evening out with the children, e.g., a dinner at a kid-friendly restaurant corresponding to a content object found in a search, followed by a concert in a nearby park. Note that multiple plans may occur on the same day, e.g., day D9 allows for golf in the daytime followed another evening out with the children. An appropriately configured model's rules, constraints and/or equations will not allow the same person to be in two places at the same time, including considering estimated travel time between places.

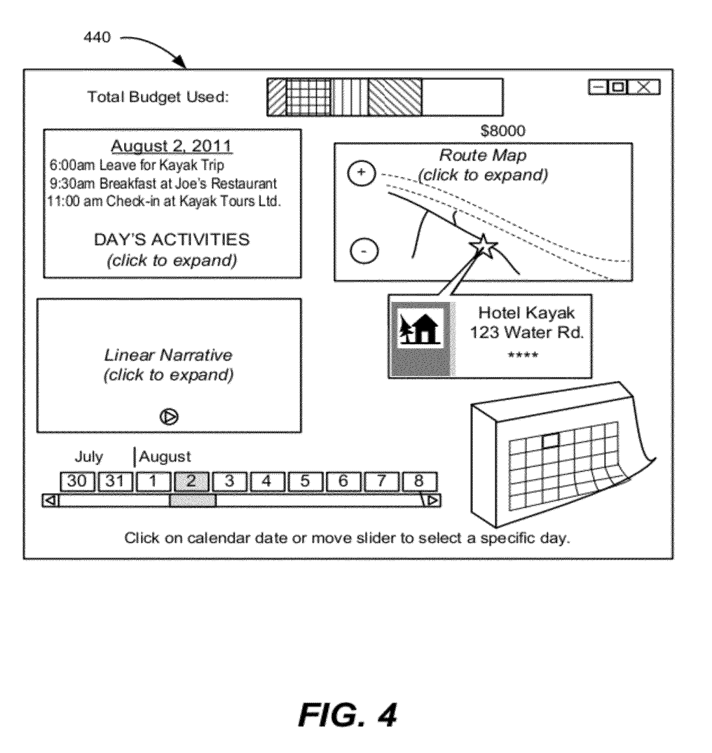

Step 208 represents processing the plan objects/content objects into the presentation. Step 210 plays back the presentation under the control of the user. For example, the user may pause or rewind a narrative, advance in a timeline, zoom in on a map, and so on. The user may also switch and select among such different types of presentations if more than one is available via the model, e.g., move the timeline to or click a calendar on August 2, see that day's schedule in a list format, and show an image of the hotel associated with that date superimposed over a map of the area in which the hotel is located. FIG. 4 shows an example of such a presentation 440.

In one aspect, the model may also present a representation of the total budget available versus that used thus far according to the choices made. The representation may be color-coded or the like to differentiate between airfare, rental car costs, hotel costs, activity costs, expected meal costs and so forth. This allows the planner to help make further choices, or to rethink previously made choices.

As described above, as represented by step 212 the user may make changes to the objects, e.g., remove an image or video and/ or category. The user may make one or more such changes. When the changes are submitted (e.g., the user selects “Re-plan with changes” or the like from a menu), step 212 returns to step 208 where a different set of objects may be re-synthesized into a new presentation, and presented to the user at step 210.

The user also may make changes to the plan, as represented via step 214. For example, a user may make a change to previously provided information, e.g., the event location may be changed, whereby a new plan is generated by the model by returning to step 208, and used to synthesize and present a new linear narrative (steps 208 and 210). Note that (although not shown this way in FIG. 2), a user may make both changes to objects and to the plan in the same interaction session, then have the plan regenerated based on both object and plan changes by returning to step 206.

The process continues until the user is done, at which time the user may save or discard the plan/presentation. If saved, the user may share that plan/presentation with another person. For example, the plan may be saved as a file containing references to the plan objects, content and the model or models that generated the plan. The presentation may be data corresponding to a read-only data capture of what the planner wants the other person to experience, although the presentation may be interactive. For example, the other person can access the plan through the web service, and can click to see different types of presentations, e.g., the linear narrative, an interactive mixed presentation 440 as in FIG. 4, and so forth.

The planner may allow the plan to be revised into a revised plan (e.g., while letting the service maintain the original). To this end, the other user selects the saved plan and may interact with the objects and/or input parameters to produce one or more revised experiences, and/or to generate a revised plan.

In another aspect, the original planner or the other person may annotate the plan with text notes, comments, audio notes, flagged items and so forth. For example, the original planner may indicate why a particular choice was made, e.g., “one company's activity was cheaper yet rated better,” or may request that the other person help out, e.g., “I liked both restaurant X and Y, but chose X—feel free to change it to Y if you'd like.”

The other person may thus re-plan the original plan (or a previous re-plan of the original), and also save the plan. Either person, or both together, may access any (two or more) saved plans and evaluate the differences between them. For example, two linear narratives may be played side-by-side, each day's activities may be viewed side-by-side or in a text-redline form, and so on.

### Exemplary Networked And Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

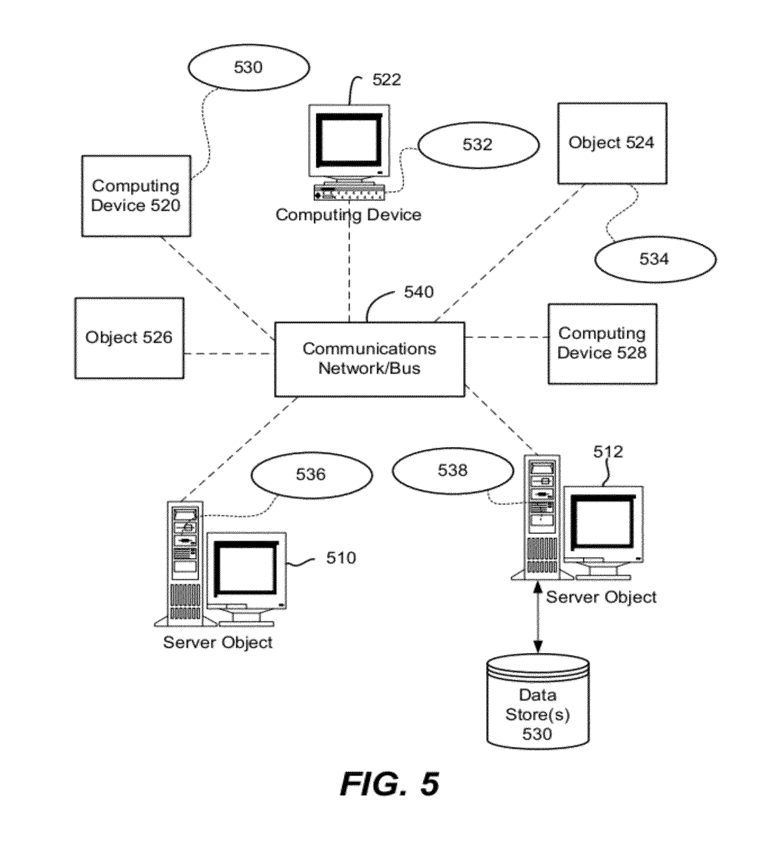

FIG. 5 provides a schematic diagram of an exemplary networked or distributed computing environment. The distributed computing environment comprises computing objects 510, 512, etc., and computing objects or devices 520, 522, 524, 526, 528, etc., which may include programs, methods, data stores, programmable logic, etc. as represented by example applications 530, 532, 534, 536, 538. It can be appreciated that computing objects 510, 512, etc. and computing objects or devices 520, 522, 524, 526, 528, etc. may comprise different devices, such as personal digital assistants (PDAs), audio/video devices, mobile phones, MP3 players, personal computers, laptops, etc.

Each computing object 510, 512, etc. and computing objects or devices 520, 522, 524, 526, 528, etc. can communicate with one or more other computing objects 510, 512, etc. and computing objects or devices 520, 522, 524, 526, 528, etc. by way of the communications network 540, either directly or indirectly. Even though illustrated as a single element in FIG. 5, communications network 540 may comprise other computing objects and computing devices that provide services to the system of FIG. 5, and/or may represent multiple interconnected networks, which are not shown. Each computing object 510, 512, etc. or computing object or device 520, 522, 524, 526, 528, etc. can also contain an application, such as applications 530, 532, 534, 536, 538, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 5, as a non-limiting example, computing objects or devices 520, 522, 524, 526, 528, etc. can be thought of as clients and computing objects 510, 512, etc. can be thought of as servers where computing objects 510, 512, etc., acting as servers provide data services, such as receiving data from client computing objects or devices 520, 522, 524, 526, 528, etc., storing of data, processing of data, transmitting data to client computing objects or devices 520, 522, 524, 526, 528, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 540 or bus is the Internet, for example, the computing objects 510, 512, etc. can be Web servers with which other computing objects or devices 520, 522, 524, 526, 528, etc. communicate via any of a number of known protocols, such as the hypertext transfer protocol (HTTP). Computing objects 510, 512, etc. acting as servers may also serve as clients, e.g., computing objects or devices 520, 522, 524, 526, 528, etc., as may be characteristic of a distributed computing environment.

### Exemplary Computing Device

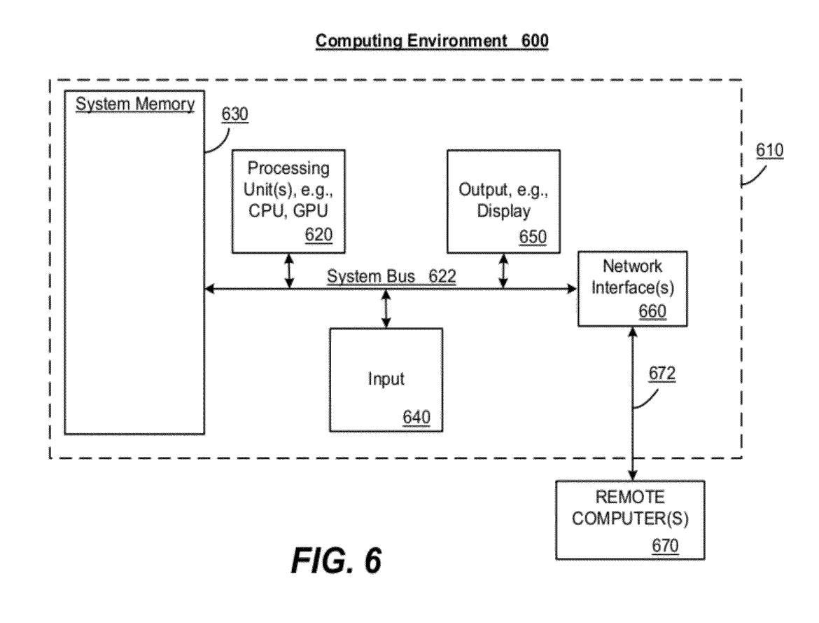

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 6 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the exemplary computing system environment 600.

With reference to FIG. 6, an exemplary remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### Conclusion

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a system, comprising:
a model configured to generate a plan, including by being configured to select and substitute content objects for plan objects based upon user input and rules, constraints or equations, or any combination of rules, constraints or equations, associated with the model, and
a presentation mechanism configured to produce a presentation based upon the plan objects.

2. The system of claim 1 wherein the plan corresponds to an event, excursion or activity, and wherein the user input includes a budget parameter.

3. The system of claim 1 further comprising a search mechanism configured to provide the content objects to the model based on a set of one or more searches, including at least one search specified by the model.

4. The system of claim 1 wherein the presentation mechanism comprises a content synthesizer configured to process at least two of the plan objects into a linear narrative

5. The system of claim 1 further comprising an interaction mechanism configured to allow one or more changes to the plan objects or content objects, or both the plan objects and the content objects, the presentation mechanism configured to reproduce the presentation based upon the one or more changes into a modified presentation.

6. The system of claim 1 further comprising an interaction mechanism configured to allow one or more changes to the input information, the model configured to regenerate a revised plan based upon the one or more changes.

7. The system of claim 1 wherein the presentation mechanism outputs a timeline, a schedule or a calendar, or any combination of a timeline, a schedule or a calendar to present data corresponding to at least part of the plan or the plan objects, or at least part of both the plan and the plan objects.

8. The system of claim 1 wherein the presentation mechanism outputs a gallery, a list, or a map, or any combination of gallery, a list, or a map to present data corresponding to at least part of the plan or the plan objects, or at least part of both the plan and the plan objects.

9. The system of claim 1 further comprising a mechanism configured to re-plan a plan into a revised plan, and a mechanism configured to compare the plan to the revised plan.

10. The system of claim 1 further comprising a mechanism configured to annotate the plan.

11. The system of claim 1 further comprising a mechanism configured to share the plan with another user, and to receive a revised plan from the other user.

12. The system of claim 1 further comprising a mechanism configured to compare the plan to the revised plan from the other user.

13. In a computing environment, a method performed at least in part on at least one processor, comprising:
searching for content objects corresponding to a model;
generating a plan from the content objects, including selecting content objects for plan objects based upon user input, and rules, constraints or equations, or any combination of rules, constraints or equations, associated with the model;
producing a presentation of the plan, including outputting data corresponding to the plan objects to a user;
detecting user interaction with the content objects or plan objects, or both the content objects and plan objects, and in response, producing a revised presentation of the plan, including outputting data corresponding to the revised plan; and
detecting user interaction that changes the user input, and in response, generating a new plan, and producing a new presentation corresponding to the new plan, including outputting data corresponding to the new plan.

14. The method of claim 13 wherein producing the presentation of the plan comprises synthesizing at least some of the content objects into a linear narrative.

15. The method of claim 13 wherein producing the presentation of the plan comprises outputting a timeline, a schedule, a calendar, a list, a gallery or a map comprising data, or any combination of a timeline, a schedule, a calendar, a list, a gallery or a map comprising data corresponding to at least some of the plan objects.

16. The method of claim 13 further comprising, maintaining data with the plan, the data corresponding to one or more user annotations.

17. The method of claim 13 further comprising, comparing the revised plan with the plan, comparing the new plan with the plan or comparing the revised plan with the new plan.

18. The method of claim 13 further comprising, sharing the plan for interaction by another user with the plan objects, content objects or input data, or any combination of the plan objects, the content objects and the input data.

19. One or more computer-readable media having computer-executable instructions, which when executed perform steps, comprising,
interacting with a user to assist the user in choosing a model and inputting parameters for that model;
generating a plan based upon the model and the parameters, including obtaining search content corresponding to plan objects;
outputting a presentation of the plan including a viewable representation of at least part of the content objects;
detecting interaction that changes the plan, one or more of the plan objects, or one or more of the content objects, or any combination of the plan, one or more of the plan objects, or one or more of the content objects; and
outputting a modified presentation of the plan based on the interaction.

20. The one or more computer-readable media of claim 19 having further computer-executable instructions comprising, annotating the plan with annotation data received from a user, and saving the plan and the annotation data in association with the plan.
